(19) United States
(12) Patent Application Publication
(10) Pub. No.: US 2024/0427389 A1
(43) Pub. Date: Dec. 26, 2024

(54) AMBIENT NOISE LEVEL DETECTION

(71) Applicant: Hewlett-Packard Development Company, L.P., Spring, TX (US)

(72) Inventors: CHIH-WEI HUANG, TAIPEI CITY (TW); YI-YING LAI, TAIPEI CITY (TW); CHIH-LING WEI, TAIPEI CITY (TW); HUNG HUA PENG, TAIPEI CITY (TW); DAVIS MATTHEW CASTILLO, SPRING, TX (US); CHING YU, TAIPEI CITY (TW)

(73) Assignee: Hewlett-Packard Development Company, L.P., Spring, TX (US)

(21) Appl. No.: 18/683,910

(22) PCT Filed: Sep. 15, 2021
(86) PCT No.: PCT/US2021/050396

§ 371 Date: Feb. 15, 2024

(51) Int. Cl. G06F 1/20; F04D 27/00; F04D 29/66; G01H 3/12

(52) U.S. Cl. CPC G06F 1/20; F04D 27/004; F04D 29/661; G01H 3/12

(57) ABSTRACT

Examples herein relate to ambient noise level detection. For instance, in some examples an electronic device includes a cooling resource and a processor resource to alter an operational speed of the cooling resource from an initial operational speed to a first altered operational speed, detect an ambient noise level, compare the ambient noise level to a first noise threshold, and restrict the operational speed of the cooling resource to be less than the initial operational speed.

### Background

Electronic devices include laptop computers, tablets, desktop computers, mobile phones, etc. that can transmit or modify energy to perform, or assist in the performance of tasks. Electronic devices include various components that generate heat during operation of the electronic device. Examples of components that generate heat include integrated circuit chips (IC)s, central processing units (CPU)s, graphical processing units (GPU)s, and powers sources, among other types of heat-generating components.

Electronic devices often include a fan. A fan can be utilized to produce a flow within a fluid. For instance, a fan can cause air to be drawn into an electronic device, circulate the air within the electronic device, and expel the air from the electronic device to cool the electronic device.

### BRIEF DESCRIPTION OF THE DRAWINGS

FIG. 1 illustrates an example of a device for providing ambient noise level detection.

FIG. 2 illustrates an example of a memory resource for providing ambient noise level detection.

FIG. 3 illustrates an example of a device that includes a controller for providing ambient noise level detection.

FIG. 4 illustrates an example of a flow diagram for providing ambient noise level detection.

FIG. 5 illustrates an example of a fan table for providing ambient noise level detection.

### DETAILED DESCRIPTION

As mentioned, electronic devices generate thermal radiation (i.e., heat) in the process of transmitting or modifying energy to perform tasks. For example, as electricity passes through wires and across circuitry in the electronic device, inherent resistance in the wires and circuitry can give rise to ohmic heating in the system, thereby producing thermal radiation (i.e., heat).

Various methodologies of mitigating thermal radiation in electronic devices can be employed. For example, cooling resources such as fans can be utilized to mitigate thermal radiation in electronic devices. As used herein, “cooling resource” such as a fan is a device that can operate to produce flow within a fluid (e.g., air). An amount of noise can be produced due to operation of the cooling resource. The amount of noise can correspond or be related to an operational speed at which the cooling resource is operating. For instance, increased fan speed can result in an increase noise level. Increased fan noise can cause a negative experience for a user of an electronic device, particularly when operating the electronic device in a quiet room which can make sound emitted by the electronic device readily perceivable by a user of the electronic device.

Alteration of operational speed of a cooling resource based on a particular ambient noise level can be sought. For instance, at a low ambient noise level (i.e., when it is quiet) it may be sought to reduce fan speed and thereby reduce an amount of audible noise attributable to operation of the fan. Conversely, when an ambient noise level is high a reduction in fan speed is not implemented as any amount of audible noise attributable to operation of the fan may go unnoticed or be tolerated by a user in the loud environment. As such, it may be sought to detect an ambient noise level. However, accurate detection of an ambient noise level is impacted by other noises such as those generated during operation of a cooling resource such as a fan.

As such, some approaches seek to detect an ambient noise level by ceasing fan operation (e.g., a blade or impeller of the fan is not rotated during detection of the ambient noise level). Some other approaches seek to filter a frequency associated with operation of the fan at a given speed. By ceasing fan operation and/or utilizing frequency filtering such methods attempt to monitor accurate ambient noise levels. However, such approaches result in a change (e.g., due to ceasing fan operation) that is perceivable by a user of the electronic device, an increased operational temperature of the electronic device (e.g., due to ceasing fan operation), and/or be computationally expensive (e.g., due to employing frequency filtering). Thus, such approaches lead to a negative user experience. Moreover, such approaches rely on an input from a user to be initiated and thus not occur autonomously.

As such, the disclosure is directed to ambient noise level detection. For instance, ambient noise level detection include alteration of an operational speed of the cooling resource from an initial operational speed to a first altered operational speed, detection of an ambient noise level (while the cooling resource is operating at the first altered operational speed), comparison of the ambient noise level to a noise threshold, and restriction of the operational speed of the cooling resource when the ambient noise level is less than the first noise threshold. For example, when the operational speed of the cooling resource is restricted to less than the initial operational speed an amount of noise emitted by the electronic device is reduced as compared to an amount of noise emitted by the electronic device when the fan is operating at the initial operational speed. Such ambient noise level detection is, in some instances, employed autonomously and continuously or periodically during operation of the electronic device. Thus, ambient noise level detection, as detailed herein, accurately detects a level of ambient noise in a manner that is not readily perceivable by a user (e.g., reduces fan speed by 2-3 decibel increments), mitigates any increase in operational temperature of the electronic device (e.g., due to maintaining some rotation of the fan), and is frequency filtering-free (i.e., does not employ computationally expensive frequency filtering).

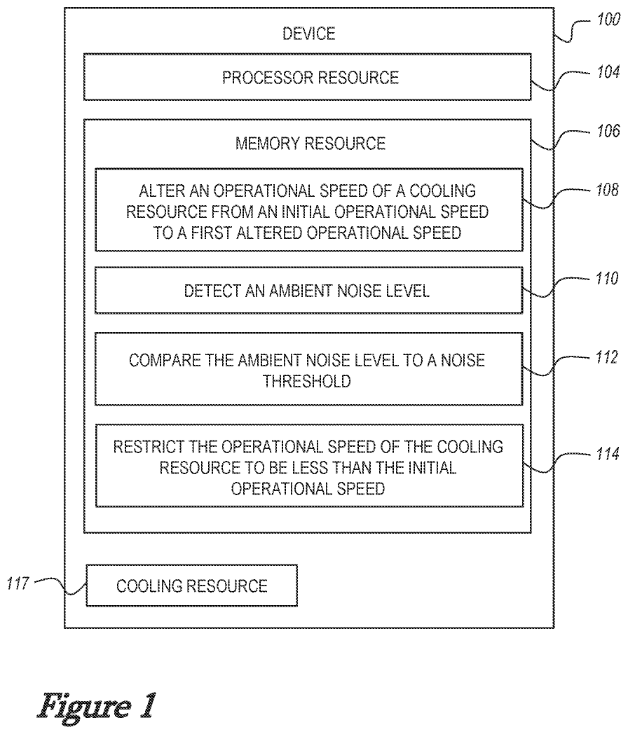

FIG. 1 illustrates an example of a device 100 for ambient noise level detection. In some examples, the device 100 includes a processor resource 104 communicatively coupled to a memory resource 106. As described further herein, the memory resource 106 includes instructions 108, 110, 112, 114 that are executable by the processor resource 104 to perform particular functions.

The device 100 is a computing device that includes components such as a processor resource 104. As used herein, the term computing device refers to an electronic system having a processor resource and a memory resource. Examples of computing devices include, for instance, a laptop computer, a notebook computer, a desktop computer, controller, and/or a mobile device (e.g., a smart phone, tablet, personal digital assistant, etc.), among other types of computing devices.

As used herein, the processor resource 104 include, but is not limited to: a central processing unit (CPU), an application specific integrated circuit (ASIC), a field programmable gate array (FPGA), a metal-programmable cell array (MPCA), a semiconductor-based microprocessor, or other combination of circuitry and/or logic to orchestrate execution of instructions 108, 110, 112, 114. In other examples, the device 100 includes instructions 108, 110, 112, 114, stored on a machine-readable medium (e.g., memory resource 106, non-transitory computer-readable medium, etc.) and executable by a processor resource 104. In a specific example, the device 100 utilizes a non-transitory computer-readable medium storing instructions 108, 110, 112, 114, that, when executed, cause the processor resource 104 to perform corresponding functions.

As illustrated in FIG. 1, the device 100 includes a cooling resource 117. In some examples, the cooling resource 117 can be a fan. As mentioned, a fan refers to a device that can operate to produce flow within a fluid (e.g., air). For instance, a fan can impart a force on a fluid and cause a flow within the fluid by way of rotation of a rotational element (e.g., an impeller). An impeller can refer to an assembly of blades and hub. For instance, blades can be coupled to a central hub and, when the hub and the blades are rotated, the blades can cause a flow of a fluid in a given direction.

In some examples, the cooling resource 117 can be a pulse-width modulated (PWM) fan, among other types of fans such as linear regulating (voltage control) fan. The fan can be caused to actuate by a direct current (DC) brushed and/or DC brushless motors, for example. The fan includes a control system (not illustrated) that can provide a signal (e.g., a variable DC voltage output provided from a DC voltage source) such as a PWM control signal to cause the fan to accurate and to control the revolution speed of the fan.

In some examples, the device 100 includes instructions 108 to alter an operational speed of the cooling resource 117 from an initial operational speed to a first altered operational speed. The device 100 includes instructions 108 to alter the operational speed of the cooling resource 117 from an initial operational speed to a first altered operational speed that is lower than the initial operation speed. For instance, the cooling resource 117 can be initially operating at a high speed during the course of typical operation of the device 100. However, an amount of noise produced by a fan during such high speed operation can be elevated, and thus impact detection of an ambient noise level.

As used herein, high speed operation refers to operation of the fan in a range from 2,000 rotations per minute to 10,000 rotations or more per minute. In such instances, the device 100 includes instructions 108 to alter the operational speed of the cooling resource 117 from an initial high operational speed to a first altered operational speed that is lower than the initial high operation speed. For example, the first altered operational speed can be associated with a lower voltage that is applied to the cooling resource to cause the cooling resource to actuate, a shorter duration at which the voltage is applied to the cooling resource, a lower quantity of rotations per minute, and/or a lower amount of noise attributable to operation of the cooling resource, than corresponding values associated with operation of the cooling resource at the initial high operational speed. Thus, alteration of the operational speed of the cooling resource 117 from the initial operational speed to the first altered operational speed can permit accurate detection of a level of ambient noise, and yet in contrast to other approaches such as those that cease operation of the fan entirely, still permits the cooling resource 117 to cool the device 100 by continued operation of the cooling resource albeit at a lower operational speed than the initial operational speed.

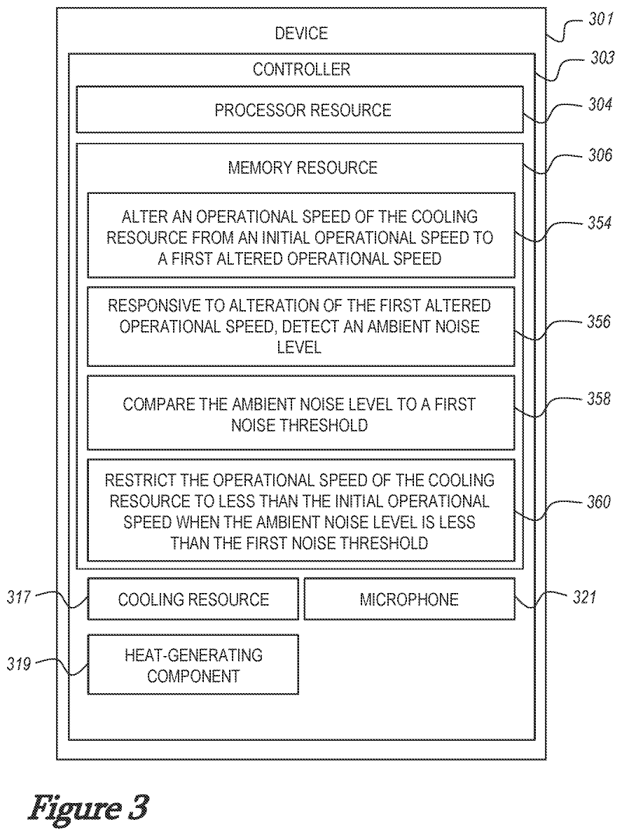

In some examples, the device 100 includes instructions 110 to detect an ambient noise level. The ambient noise level can be detected via a microphone (e.g., microphone 321 as illustrated in FIG. 3) that is included in the device 100. As used herein, a microphone refers to an electronic device that can be utilized to capture audio present near (in the ambient environment around) the device 100, for instance, by converting sound waves into electrical energy variations which can be amplified, transmitted, and/or stored.

For instance, the device 100 includes instructions to detect the ambient noise level responsive to alteration of an operational speed of the cooling resource 117 to the first altered operational speed which is lower than the initial operation speed. Thus, ambient noise level detection, as detailed herein, can detect an ambient noise level (e.g., while the cooling resource is being actuated at the first altered operational speed) with minimal or no negative impact on a user experience, and yet by continuing to operate the cooling resource 117 can cool the device 100 in contrast to other approaches such as those the cease to operate a cooling resource (e.g., fan) when attempting to detect an ambient noise level.

In some examples, the device 100 includes instructions 112 to compare the detected ambient noise level to a first noise threshold. For instance, the first noise threshold can be equal to a known noise level associated with operation of the cooling resource at the first altered operational speed. In such instances, the ambient level noise level can be lower than a known amount of noise (e.g., 70 decibels) attributable to operation of the cooling resource 117 at the initial operational speed but greater than a known amount of noise (e.g., 67 decibels) attributable to operation of the cooling component 117 at the first altered operational speed. As used herein, a known noise level refers to a monitored amount of noise that is exclusively attributable to operation of a cooling resource at a particular operational speed. For instance, noise levels of operation of a cooling resource such as a fan at various operational speed can be monitored in an anechoic chamber or otherwise to determine a known noise level at a given operational speed. Thus, the ambient noise level can be accurately detected (e.g., to be a value between 67 decibels and 70 decibels) whereas other approaches that do not account for other noises such as those emitted by a cooling resource when detecting an ambient noise level would erroneously detect a higher noise level. Yet, in contrast to other approaches such as those that cease operation of the fan entirely in an effort to account for other noises, ambient noise detection, as detailed herein, still permits the cooling resource 117 to cool the device 100 by continued operation of the cooling resource albeit at a lower operational speed than the initial operational speed. Further a cooling resource 117 can then be controlled based on the detected ambient noise level, as detailed herein.

In some examples, the known noise level associated with operation of the cooling resource at the first altered operational speed is less than a threshold amounts different than a known noise level associated with operation of the cooling resource at the initial operational speed. For instance, the threshold amount can be less than 10 decibels, less than 5 decibels, less than 3 decibels, or less than 2 decibels. In some examples, the threshold amount can be in a range from 1 decibel to 10 decibels, from 1 decibel to 5 decibels, from 1 decibel to 3 decibels, or in a range from 2 decibels to 3 decibels.

For instance, the threshold amount can be equal to 3 decibels or less in various examples. Having the known noise levels differ by less than a threshold amount can mitigate or eliminate any perception by a user of the device 100 of a change in the noise level due to alteration of the operational speed of the cooling resource 117. For instance, a change that is from 1 decibel to less than 3 decibels is not be perceivable by a user of the device due to the change being less than change of 3 decibels. Thus, ambient noise level detection, as detailed herein, can detect an ambient noise level (e.g., while the cooling resource is being actuated at the first altered operational speed) with minimal or no negative impact on a user experience.

In some examples, the device 100 includes instructions 114 to control operation of the cooling resource. For instance, the instructions 114 can restrict an operational speed of the cooling resource to be less than the initial operational speed (e.g., having a known noise level of 67 decibels) when the detected ambient noise level (e.g., a value in the range from 67 decibels to 70 decibels) is less than the first noise threshold (e.g., 70 decibels). In this way, operation of the cooling resource 117 can continue at the maximum permissible amount of cooling capability at an altered operational speed (e.g., a ceiling operational speed that is less than the initial operational speed) that is less than the detected ambient noise level and therefore is not perceivable by a user.

The noise thresholds, known noise levels, operational speeds of the cooling resource 117 and/or other information can be stored in a look-up table or other type of data structure. As used herein, the term “lookup table” refers to a matrix of data arranged as attribute-value pairs. The attribute-value pairs can be related data elements. For instance, the attribute can be a known noise level and the value can be a fan speed in RPM, among other possibilities.

In some examples, the lookup table can depend on a performance mode of the device 100. As used herein, the term “performance mode” refers to a state of operation of a computing device based on accuracy, efficiency, and speed of execution of computing device operations. For example, the computing device 100 can determine a performance mode of the computing device 100. Performance modes includes a power saver mode, a balanced, mode, a high-performance mode, etc. Such performance modes are described by factors including response time, rate of processing, utilization of computing resources, operational speed of a cooling resource, etc. For example, a high-performance mode often includes a fast response time, rate of processing, and high utilization of computing resources at the expense of increased heat generation, power consumption, high operational speed of the cooling resource 117 etc., whereas a power saver mode results in less heat generation, power consumption, lower operational speeds of the cooling resource 117, etc. but at a slower response time, rate of processing, and lower utilization of computing resources than a high-performance mode. A balanced performance mode can lie between a high-performance mode and a power saver mode.

The device 100 includes instructions to select a lookup table from a plurality of lookup tables based on the determined performance mode and/or based any restriction of the operational speed of cooling resource 117. For example, the device 100 can select a first lookup table corresponding to the high-performance mode when the computing device 100 is operating in the high-performance mode and there is no restriction on the operational speed of the cooling resource 117, select a second lookup table corresponding to the balanced performance mode when the computing device 100 is operating in the balanced performance mode and there is no or little restriction on the operational speed of the cooling resource 117, select a third lookup table corresponding to the power saver mode when the computing device 100 is operating in the power saver mode or there is a significant restriction on the operational speed of the cooling resource 117 (e.g., the cooling resource is operating in a “quiet room mode”), etc. Accordingly, control of the cooling resource 117 can depend on the performance mode of the computing device 100.

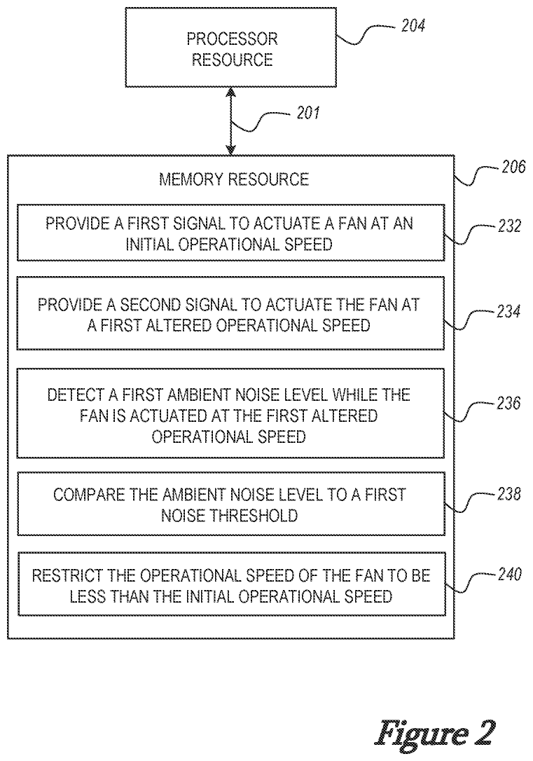

FIG. 2 illustrates an example of a memory resource 206 for ambient noise level detection. In some examples, the memory resource 206 can be a part of a computing device or controller that can be communicatively coupled to a system. For example, the memory resource 206 can be part of a device 100 as referenced in FIG. 1. In some examples, the memory resource 206 can be communicatively coupled to a processor resource 204 that can execute instructions 232, 234, 236, 238, 240 stored on the memory resource 206. For example, the memory resource 206 can be communicatively coupled to the processor resource 204 through a communication path 201. In some examples, a communication path 201 includes a wired or wireless connection that can allow communication between devices and/or components within a device or system.

The memory resource 206 is an electronic, magnetic, optical, or other physical storage device that stores executable instructions. Thus, a non-transitory machine-readable medium (MRM) (e.g., a memory resource 206), for example, is a non-transitory MRM comprising Random-Access Memory (RAM), read-only memory (ROM), an Electrically-Erasable Programmable ROM (EEPROM), a storage drive, an optical disc, and the like. The non-transitory machine-readable medium (e.g., a memory resource 206) is disposed within a controller and/or computing device. In this example, the executable instructions 232, 234, 236, 238, 240, can be “installed” on the device. In some examples, the non-transitory machine-readable medium (e.g., a memory resource) can be a portable, external or remote storage medium, for example, that allows a computing system to download the instructions 232, 234, 236, 238, 240, from the portable/external/remote storage medium. In this situation, the executable instructions are part of an “installation package”. As described herein, the non-transitory machine-readable medium (e.g., a memory resource 206) can be encoded with executable instructions for performing calculations or computing processes.

The instructions 232, when executed by a processor resource such as the processor resource 204, includes instructions to provide a first signal to actuate a fan at an initial operational speed. For instance, the signal can be a PWM signal, as detailed herein.

The instructions 234, when executed by a processor resource such as the processor resource 204, includes instructions to provide a second signal to the fan to actuate the fan at a first altered operational speed. The second signal is. in some instances, the same type of signal as the first signal. For instance, the first signal can be a PWM signal and the second signal the be a different PWM signal. In some examples, the second signal can be provided periodically (e.g., every hour, every 30 minutes, every 5 minutes, etc.) to autonomously detect an ambient noise level and thereby detect a change in an environment in which the device is located and/or a change in an environment is located (e.g., a user has taken the device from a “loud” room into a “quiet” room).

The instructions 236, when executed by a processor resource such as the processor resource 204, includes instructions to detect a first ambient noise level while the fan is actuated at the first altered operational speed, as detailed herein. The instructions 238, when executed by a processor resource such as the processor resource 204, includes instructions to compare the first ambient noise level to a first noise threshold. For instance, the first noise threshold can be equal to a known noise level associated with operation of the fan at the first altered operational speed, as detailed herein.

The instructions 238, when executed by a processor resource such as the processor resource 204, includes instructions to control operation of a cooling resource such as the fan. Control of the cooling resource includes altering an operating speed of the cooling resource. For instance, altering a plurality of permissible operating speeds to include some but not all of the plurality of permissible operating speed. For example, the cooling resource can be controlled to no longer operate at a highest and/or higher operating speed and instead operate at comparatively lower operation speed or plurality of lower operating speeds which are each have a known noise level that is less than a detected ambient noise level. For instance, as detailed herein, the instructions 238 can cause the cooling resource to operate in accordance a “quiet room mode” in with lower operating speeds of the cooling resource.

FIG. 3 illustrates an example of a device 301 that includes a controller 303 for providing ambient noise level detection. As illustrated in FIG. 3. the device 301 includes a cooling resource 317, a heat-generating component 319, and a microphone 321, among other possible components.

The heat-generating component 319 can be an integrated circuit chip (IC), central processing unit, graphical processing unit, and/or powers source, among other components that generate heat during operation of the electronic device 100. A power source refers to a source of direct current (DC) and/or a source of alternating current (AC). Examples of power sources include batteries, AC/DC power converters, and/or DC/AC power converters, among other types of power sources. The cooling resource 317, as described herein, can cool the device 301, for instance, to dissipate or otherwise reduce heat generated by the heat-generating component 319.

The controller 303 can be a computing device that includes a processor resource 304 communicatively coupled to a memory resource 306. As described herein, the memory resource 306 includes or store instructions 354, 356, 358, 360 that can be executed by the processor resource 304 to perform particular functions.

The controller 303 includes instructions that can be executed by a processor resource 304 to determine a workload of the device 301. For instance, the controller 303 includes instruction to determine a workload of a processor resource such as the processor resource 304 included in the electronic device 101. The workload can be determined in terms of a quantity of operations (e.g., read/write requests) performed by the processor device, a quantity of processes/threads and/or applications associated with (e.g., using processing capabilities of) the processor resource, and/or an amount of power/current drawn by the processor resource at a given time, among other possible ways to metric or determine a workload of the device 301 at a given time.

In some examples, the instructions can be executed by a processor resource 304 to determine the workload of the device 301 is less than a workload threshold. For instance, the instructions can be executed by a processor resource to determine a value of a determined workload is less than a threshold amount of current/power drawn by a processor resource, among other possibilities. Thus, determination of the workload and comparison to a workload threshold can preclude performance of ambient noise level detection until a value of a determined workload is less than a workload threshold. In this way, any impact on system performance/user experience is mitigated and occurs when a user is not “heavily” using the device 301 (e.g., encumbering the processor resource with a large quantity and/or magnitude of processes). Stated differently, in some examples, aspects of ambient noise level determination (e.g., alteration of an operational speed of a cooling resource) can occur exclusively when a value of a determined workload is less than a workload threshold to mitigate any impact on a user experience in contrast to other approaches (e.g., frequency filtering) that are computationally expensive and exacerbate any burden on a processor resource of a device.

In some examples, the instructions 354 can be executed by a processor resource 304 to alter an operational speed of the fan by a first increment from an initial operational speed to a first altered operational speed. For instance, as mentioned the initial speed can be altered to the first operational speed responsive to a determination that a value of a determined workload is less than a workload threshold.

In some examples, the instructions 356 can be executed by a processor resource 304 to detect, via the microphone 321, an ambient noise level around the electronic device 301. For instance, the instructions 356 can detect the ambient noise level responsive to alteration to the first altered operational speed and/or while the cooling resource is operating at the first altered operational speed.

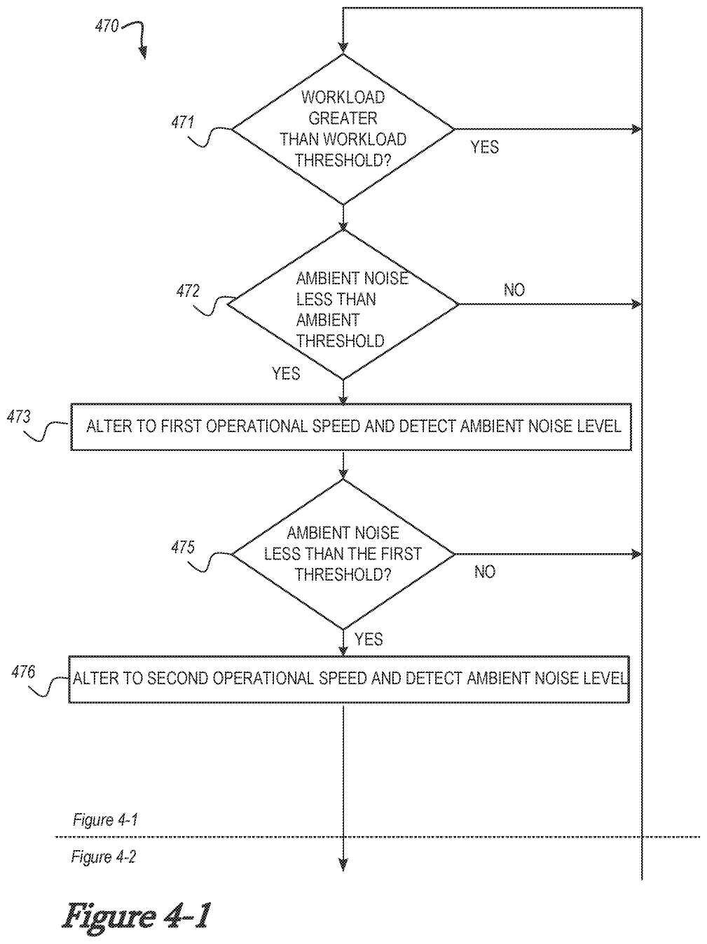

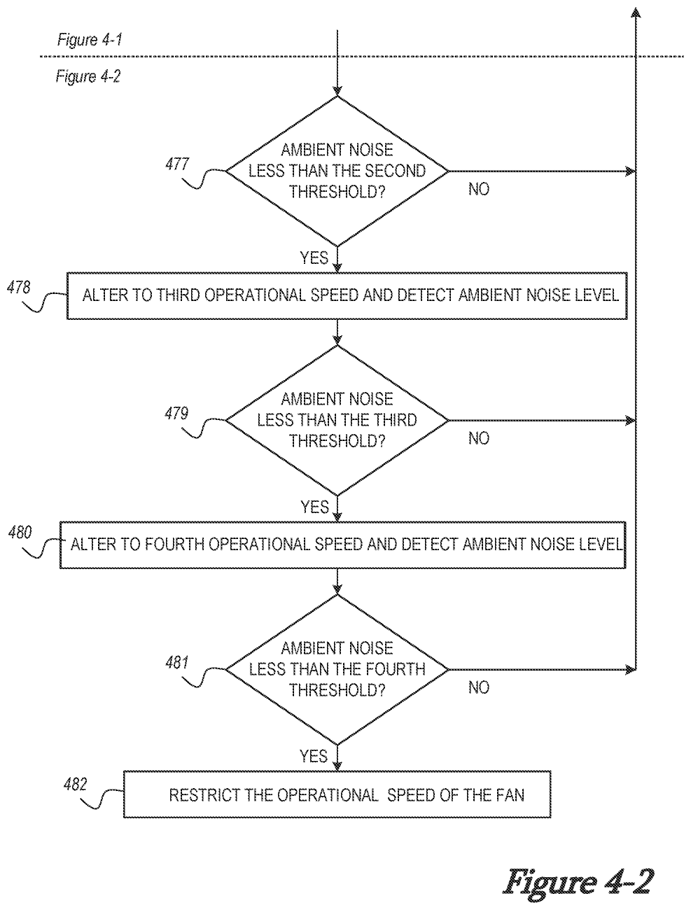

In some examples, the instructions 358 can be executed by a processor resource 304 to compare the ambient noise level to a noise threshold, as detailed herein. In some examples, the threshold is included in a plurality of noise thresholds. The plurality of noise thresholds can be equal to a known noise level associated with operation of the fan at a respective operational speed. For instance, a first noise threshold (e.g., 67 decibels) can be associated with a first operational speed, a second noise threshold (e.g., 65 decibels) can be associated with a second operational speed, a third noise threshold (e.g., 63 decibels) can be associated with a third operational speed, and a fourth noise threshold (e.g., 61 decibels) can be associated with a fourth operational speed. That is, the plurality of thresholds be progressively decreasing thresholds in a sequence to promote aspects of ambient noise level detection as detailed herein. For example, the plurality of noise threshold includes a first noise threshold, a second noise threshold that is less than the first noise threshold, a third noise threshold that is less than a second noise threshold, and a fourth noise threshold that is less than the third noise threshold, as detailed in FIG. 4. However, a quantity of noise thresholds can be increased or decreased.

In some examples, the plurality of noise thresholds can be incrementally different by the same incremental value. For instance, the same incremental value can be equal to a value in a range from 1 decibel to less than 3 decibels. For example, each noise threshold can be 2 decibels different, among other possible values. However, in some examples, the noise thresholds can be different by varying degrees such as having a second threshold that is two decibels different than (e.g., lower than) a first threshold and a third threshold that is 1 decibel different (e.g., lower than) than the second threshold.

In some examples, the instructions 360 can be executed by a processor resource 304 to restrict the operational speed of the cooling element to an altered operational speed (e.g., ceiling operational speed) that is less than the initial operational speed when the ambient noise level is less than the noise threshold, as detailed herein. In some examples, the controller 303 includes instructions (not illustrated) that can be executed by a processor resource 304 to cease restriction of the operational speed of the fan. The instructions to cease restriction (e.g., revert to fan table or mode of operation in which the initial/higher operational speeds are permitted) can occur responsive to a user input and/or responsive to detection that an ambient noise level is above a noise threshold such as being above the first noise threshold, among other possibilities.

FIG. 4 (formed of the combination of sheet 4-1 and sheet 4-1) illustrates an example of a flow diagram of a flow 470 for providing ambient noise level detection. At 471, the flow includes determination of a workload of a processor resource included in the electronic device. Responsive to a determination that the workload is greater than the workload threshold the flow 470 can stop or await a subsequent initiation of the flow 470. In such instances, an operational speed of a cooling resource is not restricted. For example, alteration of the operational speed of the cooling resource to the first altered operational speed can be delayed until the workload is less than the workload threshold. Responsive to a determination that the workload is less than a workload threshold the flow 470 can proceed to 472.

At 472, an ambient noise level can be detected and can be compared to an ambient noise threshold. In instances where the workload is sufficiently low, a cooling resource is operating at an operating speed that is low enough or stopped entirely to permit an accurate ambient noise level to be detected that would otherwise be impacted by noise attributable to higher operational speeds of the cooling resource.

In any case, detection of the ambient noise level at 472 can permit comparison of the detected ambient noise level to an ambient noise threshold (e.g., 60 decibels, etc.). Responsive to a determination that the detected ambient noise level is greater than (not less than or equal to) the ambient noise threshold the flow 470 can stop or await a subsequent initiation of the flow 470. In such instances, an operational speed of a cooling resource can be restricted, for instance, to an operational speed (e.g., a lower operational speed) of the cooling resource that is included in a “quiet room mode”. Similarly, at any point during the flow 470 that a detected ambient noise level is less than or equal to an ambient noise threshold the flow 470 can stop and operating speed of the cooling resource can be altered in accordance with a “quiet room mode”. Conversely, responsive to a determination that the detected ambient noise level is less than the ambient noise threshold the flow 470 can proceed to 473.

At 473, an operational speed of a cooling resource such as a fan can be altered to a first altered operational speed and an ambient noise level (i.e., a first ambient noise level detected at an altered operational speed) can be detected, as detailed herein. At 475, the detected ambient noise level, as detected at 473, can be compared to a first noise threshold, as detailed herein. Responsive to a determination that the detected ambient noise level is greater than the first noise threshold the flow 470 can stop or await a subsequent initiation of the flow 470. In such instances, an operational speed of a cooling resource is not restricted. Responsive to a determination that the detected ambient noise level, as detected at 473, is less than the first noise threshold the flow 470 can proceed to 476.

At 476, an operational speed of a cooling resource such as a fan can be altered from the first altered operational speed to a second altered operational speed and an ambient noise level can be detected, as detailed herein. At 477, the detected ambient noise level, as detected at 476, can be compared to a second noise threshold, as detailed herein. As detailed herein the second noise threshold can be less than (e.g., 2-3 decibels less than) the first noise threshold. Responsive to a determination that the detected ambient noise level is greater than the second noise threshold the flow 470 can stop or await a subsequent initiation of the flow 470. In such instances, an operational speed of a cooling resource is not restricted. Responsive to a determination that the detected ambient noise level, as detected at 476, is less than the second noise threshold the flow 470 can proceed to 478.

At 478, an operational speed of a cooling resource such as a fan can be altered from the second altered operational speed to a third altered operational speed and an ambient noise level can be detected. At 479, the detected ambient noise level, as detected at 478, can be compared to a third noise threshold. As detailed herein the third noise threshold can be less than (e.g., 2-3 decibels less than) the second noise threshold. Responsive to a determination that the detected ambient noise level is greater than the third noise threshold the flow 470 can stop or await a subsequent initiation of the flow 470. In such instances, an operational speed of a cooling resource is not restricted. Responsive to a determination that the detected ambient noise level, as detected at 478, is less than the third noise threshold the flow 470 can proceed to 480.

At 480, an operational speed of a cooling resource such as a fan can be altered from the third operational speed to a fourth altered operational speed and an ambient noise level can be detected, as detailed herein. At 481, the detected ambient noise level, as detected at 480, can be compared to a fourth noise threshold, as detailed herein. As detailed herein the fourth noise threshold can be less than (e.g., 2-3 decibels less than) the third noise threshold. Responsive to a determination that the detected ambient noise level is greater than the fourth noise threshold the flow 470 can stop or await a subsequent initiation of the flow 470. In such instances, an operational speed of a cooling resource is not restricted. Responsive to a determination that the detected ambient noise level, as detected at 480, is less than the fourth noise threshold the flow 470 can proceed to 482.

At 482, the operational speed of the cooling resource can be restricted. For instance, the operational speed of the cooling resource can be restricted to an operational speed that is less than the initial operating speed, less than the first altered operating speed, less than the second altered operating speed, less than third altered operating speed and less than the further operating speed. That is, is some examples, the operating speed of the cooling resource can be restricted to an operating speed that is less than or equal to the fourth altered operating speed. For instance, in some examples, the cooling resource can be restricted to operate in accordance a “quiet room mode” having lower operating speeds of the cooling resource.

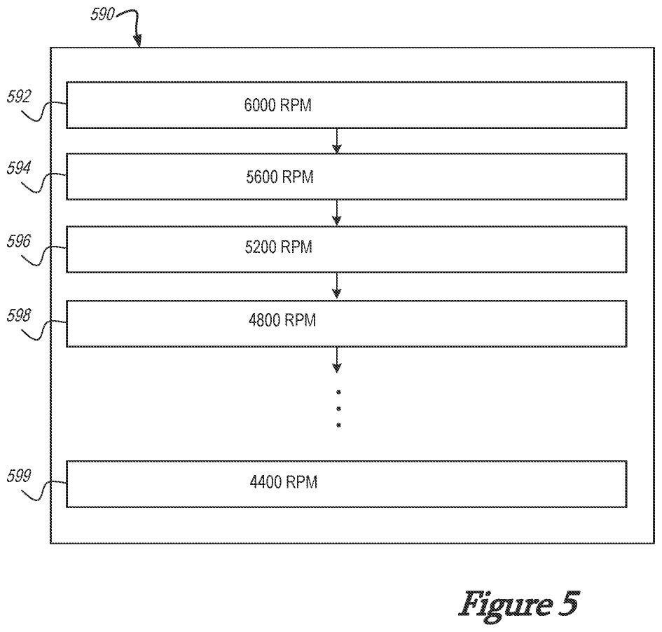

FIG. 5 illustrates an example of a fan table 590 for providing ambient noise level detection. In some instance, the fan table 590 is built into a BIOS of a computing device. The fan table 590 includes different operational speed of a cooling resource such as a fan and their associated noise/decibel levels. Using the fan table, the operational speed of the cooling resource can be altered (e.g., from an initial operational speed to a first altered operational speed). The operational speeds such as a given quantity of rotations per minute (RPMs) can be preset into the BIOS, and the cooling resource operates at or between those preset cooling resource operational speeds. For instance, a signal sent to the cooling resource can be varied to adjust an actual operational speed of the cooing resource based on the operational speeds or other information included in the fan table 590.

For example, the fan table 590 as illustrated in FIG. 5 includes an initial operational speed 592 (e.g., a first entry) at 6000 RPM. The initial operational speed 592 is based on a size of a cooling resource among other factors such as a noise threshold. For instance, at 6000 RPM a cooling resource, in some instances, emits noise that is less than or equal to a given noise threshold (e.g., 60 decibels, 50 decibels, or 45 decibels, etc.).

The fan table 590 includes a first altered operational speed 594 (e.g., at 5600 RPM having a corresponding noise level of ˜43-42 decibels) that is a threshold amount (e.g., 400 RPM) different than the initial operational speed 592, a second altered operational speed 596 (e.g., at 5200 RPM having a corresponding noise level of ˜41-40 decibels), a third altered operational speed 598 (e.g., at 4800 RPM having a corresponding noise level of ˜39-38 decibels), and a fourth altered operational speed 599 (e.g., at 4400 RPM having a corresponding noise level of ˜37-36 decibels). A mentioned, an amount of difference between the altered operational speed is less than a threshold amount to ensure that alteration of the operational speed of the cooling resource is not perceptible to a user of an electronic device. The quantity of altered operation speeds, and/or the particular values of the initial operational speed and/or values of the quantity of altered operation speeds are variable depending on a size of a cooling resource, a noise threshold, etc.

The figures herein follow a numbering convention in which the first digit corresponds to the drawing figure number and the remaining digits identify an element or component in the drawing. Similar elements or components between different figures are identified by the use of similar digits. For example, 104 references element “04” in FIG. 1, and a similar element is referenced as 204 in FIG. 2.

Elements shown in the various figures herein are capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

The above specification and examples provide a description of the method and applications and use of the system and method of the present disclosure. Since many examples can be made without departing from the scope of the system and method, this specification merely sets forth some of the many possible example configurations and implementations.

What is claimed is:

1. An electronic device comprising:
a cooling resource; and
a processor resource to:
alter an operational speed of the cooling resource from an initial operational speed to a first altered operational speed;
responsive to alteration to the first altered operational speed, detect an ambient noise level;
compare the ambient noise level to a first noise threshold that is equal to a known noise level associated with operation of the cooling resource at the first altered operational speed; and
restrict the operational speed of the cooling resource to be less than the initial operational speed when the ambient noise level is less than the first noise threshold.

2. The electronic device of claim 1, wherein the known noise level associated with operation of the cooling resource at the first altered operational speed is less than a threshold amount different than a known noise level associated with operation of the cooling resource at the initial operational speed.

3. The electronic device of claim 2, wherein the threshold amount is equal to 3 decibels or less.

4. The electronic device of claim 1, wherein the instructions are executable by the processor resource to:
determine a workload of a processor resource in the electronic device;
compare the workload to a workload threshold; and
alter the operational speed of the cooling resource from the initial operational speed to the first altered operational speed when the workload is less than the workload threshold.

5. The electronic device of claim 1, wherein the instructions are executable by the processor resource to:
monitor a workload of a processor resource in the electronic device;
determine the workload is greater than the workload threshold; and
delay the alteration of the operational speed of the cooling resource to the first altered operational speed until the workload is less than the workload threshold.

6. The electronic device of claim 1, wherein the cooling resource is a fan, and wherein the wherein the instructions are executable by the processor resource to provide a signal to the fan to alter an operational speed of the fan, and wherein the signal further comprises a pulse-width modulated (PWM) signal.

7. A non-transitory computer readable medium storing instructions executable by a processor resource of a computing device to:
provide a first signal to actuate a fan of the computing device at an initial operational speed;
provide a second signal to the fan to actuate the fan at a first altered operational speed;
detect a first ambient noise level while the fan is actuated at the first altered operational speed;
compare the first ambient noise level to a first noise threshold that is equal to a known noise level associated with operation of the fan at the first altered operational speed; and
restrict the operational speed of the fan to less than the initial operational speed when the first ambient noise level is less than the first noise threshold.

8. The medium of claim 7, further comprising instructions that are executable to restrict the operational speed of the fan to be less than or equal to the first altered operational speed.

9. The medium of claim 7, wherein the first altered operational speed is less than the initial operational speed.

10. The medium of claim 8, further comprising instructions that are executable to:
provide a third signal to the fan to actuate the fan at a second altered operational speed that is less than the first altered operational speed when the ambient noise level is less than the first noise threshold;
detect a second ambient noise level while the fan is actuated at the second altered operational speed;
compare the second ambient noise level to a second noise threshold that is equal to a known noise level associated with operation of the fan at the second altered operational speed; and
restrict the operational speed of the fan to less than the first altered operational speed when the second ambient noise level is less than the second noise threshold.

11. An electronic device comprising:
a processor resource;
a heat-generating component;
a fan:
a microphone; and
a controller to:
determine a workload of the processor resource is less than a workload threshold;
alter an operational speed of the fan by a first increment from an initial operational speed to a first altered operational speed;
responsive to alteration to the first altered operational speed, detect via the microphone an ambient noise level around the electronic device;
compare the ambient noise level to a first noise threshold included in a plurality of noise thresholds that are equal to a known noise level associated with operation of the fan at a respective operational speed; and
restrict the operational speed of the fan to less than the initial operational speed when the ambient noise level is less than the first noise threshold.

12. The electronic device of claim 11, wherein the controller is to detect the ambient noise level while the fan is actuated at the first altered operational speed.

13. The electronic device of claim 11, wherein the plurality of noise thresholds include the first noise threshold, a second noise threshold that is less than the first noise threshold, a third noise threshold that is less than a second noise threshold, and a fourth noise threshold that is less than the third noise threshold.

14. The electronic device of claim 13, wherein each of the plurality of noise thresholds is incrementally different by the same incremental value.

15. The electronic device of claim 14, wherein the same incremental value is equal is in a range from 1 decibel to less than 3 decibels.
